(19) United States
(12) Patent Application Publication
(10) Pub. No.: US 2008/0078780 A1
(43) Pub. Date: Apr. 3, 2008

(54) Automatic dispenser

(76) Inventors: Nancy S. Sanger, Brockport, NY (US); H. Bradley Calkins, Rochester, NY (US); David G. Simmons, Ft. Myers, FL (US)

Correspondence Address: HODGSON RUSS LLP;THE GUARANTY BUILDING, 140 PEARL STREET, SUITE 100, BUFFALO, NY, 14202-4040, US

(21) Appl. No.: 11/906,892

(22) Filed: Oct. 3, 2007

Related U.S. Application Data
(60) Provisional application No. 60/849,056, filed on Oct. 3, 2006.

(51) Int. Cl. G01F 11/00; B67D 5/06; B67D 5/08

(52) U.S. Cl. 222/1; 222/181.3; 222/638; 222/23

(57) ABSTRACT

An automatic dispenser for dispensing a liquid such as a cleaning or disinfecting liquid to a fixture. The dispenser includes a housing with a reservoir. A removable container of liquid is installed in the housing such that the liquid flows by gravity through the opening in the container into the reservoir. A pinch valve controls the flow of liquid from the reservoir and provides for a reliable dispensing system aided by gravity.

### CROSS-REFERENCE TO RELATED APPLICATION

This application claims the benefit of U.S. Provisional Patent Application No. 60/849,056 filed on Oct. 3, 2006, which is incorporated herein by reference.

### FIELD OF THE INVENTION

The present invention relates to automatic liquid dispensers.

### BACKGROUND OF THE INVENTION

Automatic liquid dispensers are used in many applications. One example is the dispensing of cleaning detergents into bathroom fixtures. Typically, a self-contained unit having a reservoir for storage of the liquid and having a battery operated pump is used. A common type of dispenser utilizes a piston-type pump to draw liquid from the reservoir into a conveying tube. There are some drawbacks related to these type of dispensers. Piston-type pumps are prone to losing prime which renders the pump inoperative. Also, the amount of liquid that is drawn from the reservoir will vary depending on the level of the liquid in the reservoir. When the reservoir is full there is less suction required to dispense the liquid, whereas when the reservoir is low it is more difficult to pull the liquid from the reservoir. What is needed is an automatic dispenser that dispenses a consistent quantity of liquid and is more reliable than piston-type pumps.

### SUMMARY OF THE INVENTION

The present invention meets the above-described need by providing a dispenser having a battery operated pinch valve that allows a liquid to be conveyed from a reservoir by means of the force of gravity. A bottle containing a charge of liquid for the reservoir with a presealed opening is disposed on the reservoir tray. The automatic dispenser is controlled by an electrical circuit that, in addition to providing timed operation of the pinch valve, provides an on/off switch and warning lights for low levels of liquid or low battery conditions.

### BRIEF DESCRIPTION OF THE DRAWINGS

The invention is illustrated in the drawings in which like reference characters designate the same or similar parts throughout the figures of which:

FIG. 1 is a perspective view of a typical application for the automatic dispenser of the present invention;

FIG. 2 is a top plan view of the base of the present invention;

FIG. 3A is a top plan view of the automatic dispenser of the present invention;

FIG. 3B is a detailed view of a portion of the dispenser;

FIG. 4 is a top plan view of the cover of the present invention;

FIG. 5 is a top plan view of the control panel of the present invention;

FIG. 6 is a detailed view of the valve according to the present invention;

FIG. 7A is a side elevational view of the reservoir tray of the present invention;

FIG. 7B is a top plan view of a cover;

FIG. 8 is a side elevational view of the bottle of the present invention; and,

FIG. 9 is a bottom plan view of the bottle of FIG. 8.

### DETAILED DESCRIPTION OF THE INVENTION

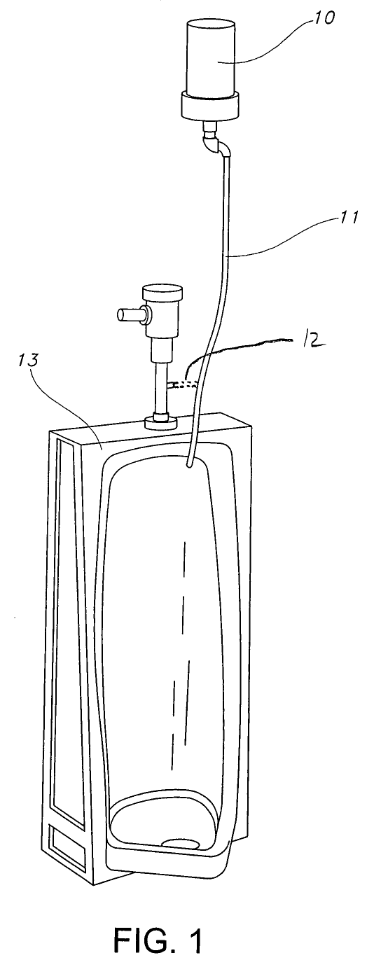

Referring to FIG. 1, a typical application for the automatic dispenser 10 of the present invention is for dispensing liquid cleaning detergents through a conduit 11 to a fixture 13 such as a toilet or urinal. As shown, the liquid detergents are typically gravity fed from the outlet of the dispenser 10 to the fixture 13. The conduit 11 may feed directly to the fixture 13 or a plumbed connection as shown by dashed lines 12 may be utilized. The dispenser 10 dispenses liquids automatically on a predetermined, periodic basis as will be described in greater detail below. The dispenser 10 may be molded from any suitable plastic material such as polypropylene or the like or it may be formed from other suitable materials as will be evident to those of ordinary skill in the art based on this disclosure.

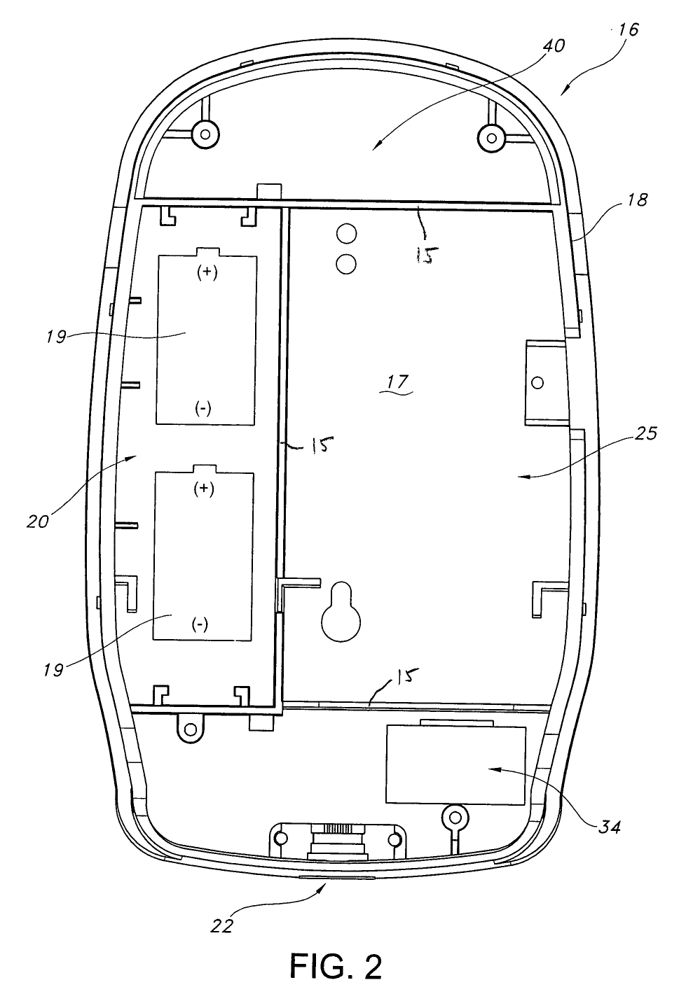

Turning to FIG. 2, the base 16 of the dispenser 10 includes a bottom wall 17, an upstanding outer wall 18, and several dividing walls 15 that define compartments within the base 16. A compartment 20 for placement of batteries 19 is shown on the left hand side of the figure. The base 16 also includes an outlet 22 where the liquid passes out of the dispenser 10. Above the outlet 22, a compartment 25 provides a space for a reservoir tray 28 (FIG. 3) and a bottle 31 (FIG. 3) of liquid detergent. A compartment 34 provides a space for receiving a valve 37 (FIG. 3). At the top of the base 16, there is a compartment 40 that receives a control panel 43 (best shown in FIG. 5).

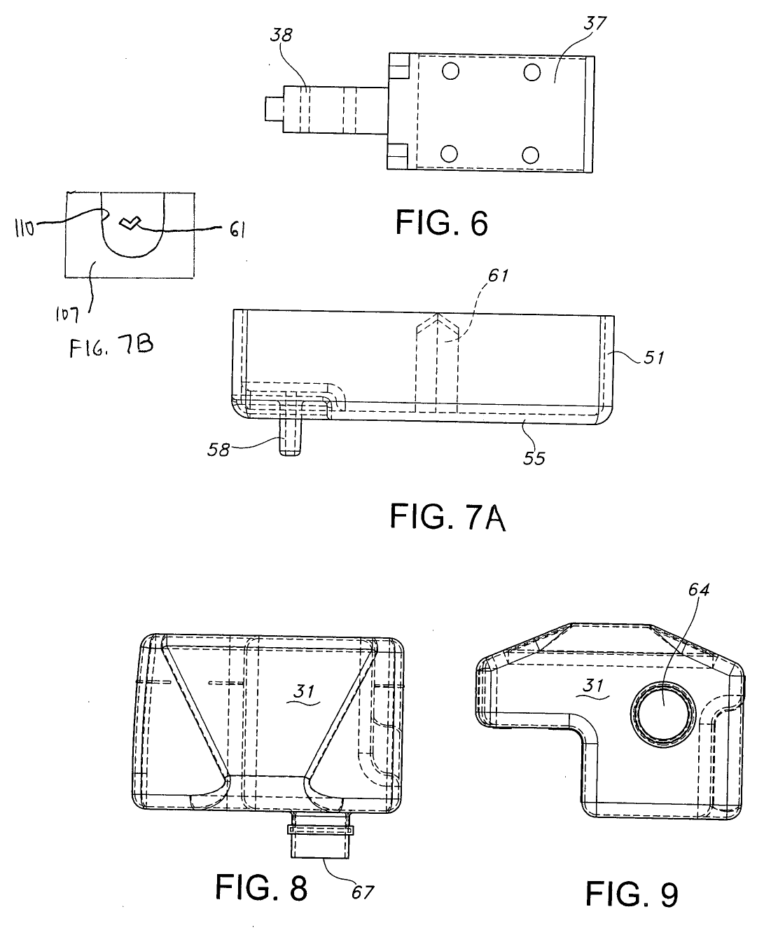

In FIG. 3A, the dispenser 10 is shown with the liquid dispensing components installed. At the bottom of the dispenser 10 the outlet 22 has a tube stub 46 for connecting to tubing 11 (FIG. 1). The valve 37 is located above the outlet 22. As shown, the valve 37 may be a pinch valve having an aperture 38 for receiving flexible tubing 48. The valve 37 may be normally closed such that the tubing 48 is pinched to prevent flow. On a predetermined periodic basis, the pinch valve 37 is actuated by the electrical circuit such that the valve 37 opens to allow flow of liquid detergent to pass through the tubing 48 via the force of gravity. A detailed view of the pinch valve 37 is shown in FIG. 6. The pinch valve 37 has an aperture 38 located at a distal end. The aperture 38 is closed by means of a pinching mechanism that moves back and forth to open and close the aperture 38 which restricts the flow of the liquid detergent through the tubing 48.

The reservoir tray 28 is positioned above the pinch valve 37. As best shown in FIG. 7A, the reservoir tray 28 has side walls 51 and a bottom wall 55 sized to receive a charge of liquid detergent from the bottle 31. The tray 28 has a outlet 58 where liquid detergent flows via gravity to the valve 37. The tray 28 may also include an upstanding piercing member 61. The piercing member 61 is designed to pierce a seal formed by frangible substrate 64 (FIG. 9) located at the opening 67 (FIG. 8) on the bottle 31 (FIG. 8). In order to install the bottle 31 in the dispenser 10, the bottle 31 is inverted and the pre-sealed opening 67 is pushed down onto the piercing member 61 causing the substrate 64 to break which allows liquid detergent from inside the bottle 31 to flow into the reservoir tray 28. The bottle 31 may be constructed of a molded plastic material or other suitable material for storing the liquid detergent. The opening of the bottle 31 by means of the piercing member 61 does not require any pouring or measuring of the liquid detergent and is designed so as to not require any contact with the liquid detergent by the maintenance personnel. Alternatively, a cap on the bottle can be removed and then the bottle 31 can be inverted and positioned above the tray.

As shown in FIG. 7B, the tray 28 may be provided with a cover 107 having a curved opening 110.

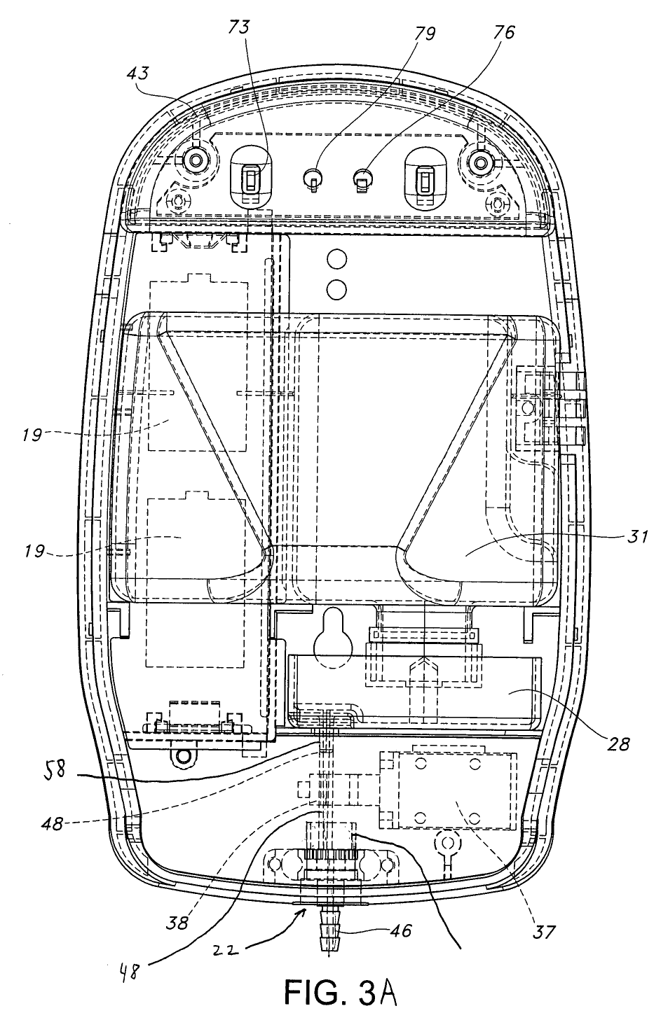

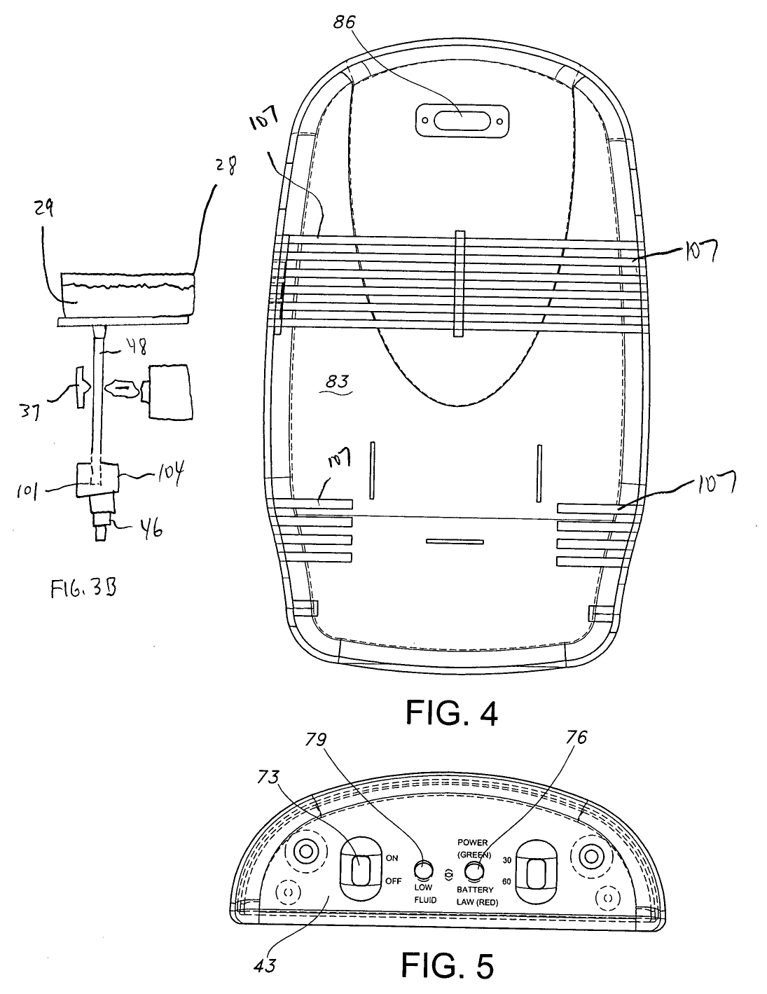

Returning to FIG. 3A, the bottle 31 is shown installed above the reservoir tray 28. At the top of the figure, the control panel 43 is shown with an on-off switch 73, a low battery indicator light 76 and a low liquid indicator light 79. The low liquid level indication may be based on elapsed time or a level sensor could be installed in the reservoir tray 23 as will be evident to those of ordinary skill in the art based on this disclosure. The control panel 43 is shown in greater detail in FIG. 5. The valve 37 and indicator lights 76, 79 may be powered by batteries 19 (FIG. 1). The electrical circuit for providing power to the control system, for time-based opening of the valve 37, and for the indicator lights 76, 79 is not detailed herein as it it will be evident to those of ordinary skill in the art based on this disclosure. Turning to FIG. 3B, the reservoir tray 28 is shown with liquid detergent 29 contained therein. The outlet 58 of the tray 28 is connected to tubing 48 that is flexible and positioned such that flow inside the tubing 48 can be stopped by means of the pinch valve 37. The tubing 48 has an end portion 101 that terminates inside an open cup 104. The break in the line allows ambient air surrounding the cup 104 to enter the system to eliminate problems with siphoning or venturi effects caused by pressure differences. Also, the open system design provides a pathway for fragrance from the liquid 29 to leave the dispenser 10, via the vents 107 (FIG. 4) in the cover 83 of the unit, to provide a fragrance in the area surrounding the automatic dispenser 10. The liquid 29 may have viscosity in the range of 1.6-1.9 cps (centipoise) for best results.

In FIG. 4, an outer cover 83 is shown. The outer cover 83 pivotally attaches to the base 16 such that it can be pivoted downward to provide access to the inside of the base 16. A window 86 may be covered with a transparent material such that the indicator lights 76, 79 may be viewed therethrough.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. An automatic dispenser, comprising:
a housing having a cover and a base defining a cavity;
a reservoir disposed in the cavity, the reservoir having an open top and having an outlet;
a valve operatively associated with the reservoir to control the flow of a liquid therefrom;
a removable container having a pre-sealed opening and having a neck sized to fit into the open top of the reservoir;
wherein the container is installed in the cavity such that the liquid flows by gravity from the container to the reservoir.

2. The automatic dispenser of claim 1, wherein the valve is a pinch valve.

3. The automatic dispenser of claim 1, further comprising an upstanding piercing member disposed in the reservoir, the upstanding piercing member aligned so as to pierce the seal on the removable container when it is positioned in the reservoir.

4. The automatic dispenser of claim 1, further comprising a flexible conduit disposed between the reservoir and an outlet disposed on the housing.

5. The automatic dispenser of claim 4, further comprising a pinch valve operatively associated with the flexible conduit.

6. The automatic dispenser of claim 5, further comprising a tube extending from the outlet of the housing to a restroom fixture, the dispenser mounted above the fixture such that the liquid is fed by gravity from the reservoir to the restroom fixture when the valve is opened.

7. The automatic dispenser of claim 1, wherein the valve is opened on a predetermined periodic basis.

8. The automatic dispenser of claim 1, further comprising a low liquid indicator light.

9. The automatic dispenser of claim 1, further comprising a low battery indicator.

10. An automatic dispenser, comprising:
a housing having a cover and a base defining a cavity, the housing having an outlet;
a reservoir disposed in the cavity, the reservoir having an open top, the reservoir having an outlet;
a flexible conduit disposed between the outlet of the reservoir and the outlet of the housing;
a pinch valve disposed between the reservoir and the outlet of the housing and operatively associated with the flexible conduit such that flow of a liquid through the flexible conduit is controlled by operation of the valve on the flexible conduit;
a removable container containing the liquid, the container having a pre-sealed opening and having a neck sized to fit into the open top of the reservoir;
wherein the container is installed in the cavity such that the liquid flows by gravity into the reservoir.

11. The automatic dispenser of claim 10, wherein the valve is opened on a predetermined periodic basis.

12. The automatic dispenser of claim 10, further comprising a low liquid indicator light.

13. The automatic dispenser of claim 10, further comprising a low battery indicator.

14. The automatic dispenser of claim 10, further comprising a control panel supplied with power from a battery.

15. A method of dispensing a liquid, comprising:
providing a housing having a cover and a base defining a cavity, a reservoir disposed in the cavity, the reservoir having an upstanding piercing member, a valve operatively associated with the reservoir to control the flow of a liquid therefrom;
providing a removable container for the liquid, the container having an opening sealed by a frangible substrate;
installing the container in the cavity such that the piercing member pierces the substrate to allow liquid to flow by gravity into the reservoir; and,
opening the valve to allow liquid to exit the reservoir.

16. The method of claim 15, further comprising providing a flexible conduit extending between the outlet of the reservoir and an outlet of the housing.

17. The method of claim 16, wherein the outlet of the housing has an adapter for receiving an end of a flexible tube.

18. The method of claim 17, wherein the flexible tube extends to a restroom fixture.

19. The method of claim 15, wherein the valve is opened on a predetermined periodic basis.

20. The method of claim 15, further comprising a low liquid indicator light.
